(19) United States
(12) Patent Application Publication
(10) Pub. No.: US 2026/0036363 A1
(43) Pub. Date: Feb. 5, 2026

(54) SYSTEM FOR SUPPLYING CO2 GAS TO A FACILITY THAT REQUIRES CO2 OR A MIXTURE COMPRISING CO2, SUCH AS AN ABATTOIR OR A GREENHOUSE FOR CULTIVATING PLANTS

(71) Applicant: Air Liquide France Industrie, Paris (FR)

(72) Inventors: Franck COUSIN, Saint Brevin les Pins (FR); Pauline LE DRU, Beaucouzé (FR); Fabien JANUARD, Herblay (FR); Etienne CHARVE, Wiler (CH)

(21) Appl. No.: 19/099,621

(22) PCT Filed: Jul. 7, 2023
(86) PCT No.: PCT/EP2023/068890

§ 371 Date: Jan. 29, 2025

(30) Foreign Application Priority Data
Aug. 9, 2022 (FR) FR2208204

(51) Int. Cl. F25J 1/02; A01G 9/18; A22B 3/00; F25J 1/00

(52) U.S. Cl. CPC F25J 1/0235; A01G 9/18; A22B 3/005; F25J 1/0027; F25J 1/0075; F25J 1/0221

(57) ABSTRACT

A method for supplying CO₂ gas to a site comprising a facility (20) that requires CO₂ or a mixture comprising CO₂, such as an abattoir or a greenhouse for cultivating plants, comprises the following steps: a boiler (4) capable of supplying hot water to the site is arranged within the site, the boiler carrying out the process of oxycombustion between a fuel (14) and pure oxygen (1), the oxygen that supplies the boiler being obtained from a liquid oxygen source present on the site; and some or all of the CO₂ contained in the flue gas produced by the boiler is recovered by transferring heat between the flue gas and the liquid oxygen in an exchanger (2).

### Cross Reference to Related Applications

This application is a 371 of International Application No. PCT/EP2023/068890, filed Jul. 7, 2023, which claims priority to French Patent Application No. 2208204, filed Aug. 8, 2022, the entire contents of which are incorporated herein by reference.

### Background

The present invention relates to processes and installations using gaseous CO₂, in particular in the food-processing industry.

This field includes in particular the drinks sector, modified atmospheres for the preservation of foodstuffs, or the anesthesia of poultry in abattoirs, or also the cultivation of plants in greenhouses.

The requirement for CO₂ in developed countries is still increasing (in particular for the abovementioned applications).

This CO₂ results predominantly from fertilizer and methanol (by-product) factories or else from factories for the production of hydrogen. The availability of this molecule is consequently becoming critical due to frequent stoppages of fertilizer production factories and to geopolitical tensions, which then have a strong impact on the price of the gas.

There is then commonly observed in many countries, due to these frequent crises, the fact that, for example, greenhouse growers have not been supplied with commercial CO₂ for several months of the year in recent years, which has, as well understood, a direct impact on their productivity.

To this are added strong environmental constraints, due to the desire of developed countries to reduce greenhouse gas emissions, which will have a direct impact on methods for the production of CO₂, by promoting the search for solutions targeted at reducing the carbon footprint.

Summary

The present invention attempts to provide an innovative solution for producing

CO₂ on the actual site of a user of this CO₂.

As will be seen in greater detail in that which follows, the present invention proposes to use the item(s) of equipment for the production of heat (boilers) conventionally present on such sites, by converting it or them to oxy-fuel combustion. In this way, the heat produced by the boilers will result from the production of CO₂ and for this reason be regarded as “unavoidable heat” within the legislative sense.

Oxy-fuel combustion is a combustion process in which the oxidant gas is no longer air but “pure” oxygen (i.e. characterized by a purity generally of greater than 95%, and 99% for liquid oxygen).

Oxy-fuel combustion (thus with oxygen and not with air) is already employed by certain industries operating at high temperature (glass works, cement works, metallurgy works, and the like) since it provides a number of advantages, among which may be mentioned:
The reduction in the volume of the flue gases by virtue of the reduction in/removal of the nitrogen ballast.
The increase in the thermal efficiency directly related to the decrease in the volume of the flue gases (due to lower heat losses in the flue gases).
The intensification of the heat transfers by virtue of two phenomena: the increase in the flame temperature and the increase in the radiation heat flows due to flue gases essentially composed of emitting gases (CO₂, H₂O).
The reduction in polluting emissions of thermal NOx or dioxins type (related to the reduction in the volume of oxidant). The specialized literature reports gains here ranging from 10% to 40% with regard to the fuel. The heating of the oxidant and of the fuel also makes possible a fall in the consumption of the latter.

Specifically, the objective is to increase the CO₂ content of the combustion flue gases by removing the nitrogen ballast, these then containing predominantly CO₂ and water.

The purer the oxygen used for the combustion, the closer the combustion flue gases are to an H₂O/CO₂ binary mixture. The main stage of the capturing of CO₂ then consists in condensing the water.

Another important advantage lies in the reduction in the volume of the flue gases to be treated. The residual contaminants are less diluted than in combustion in combustible air.

The present invention is thus concerned with sites which use CO₂, moreover provided with a boiler capable of supplying hot water to the site, this boiler, in particular condensation boiler, employing oxy-fuel combustion between a fuel (CH₄, C₃H₈, and the like) and pure oxygen, the oxygen feeding the boiler being obtained from a liquid oxygen source present on the site, and then, according to the present invention, all or part of the CO₂ contained in the flue gases produced by the boiler is recovered, in that heat exchange between said flue gases and the liquid oxygen in a exchanger is arranged.

Specifically, it is to the credit of the present invention to have proposed to take advantage of the “free” cold of the liquid oxygen already present on the site to purify and in some cases liquefy the CO₂ present in the flue gases produced by the boiler, this being the case without the contribution of electrical energy which would normally be necessary for such a change in state (by compression/expansion).

The “pure” CO₂ thus obtained (recovered) in its gas or liquid form can be stored (sequestered) for the purpose of subsequent use on the site under consideration, or else used “as a just-in-time stream”, as a stream “synchronized” with the hot water requirement and thus the operation of the boiler.

The heat exchanger used can be, by way of illustration, a plate exchanger or also a tubular exchanger.

Within the exchanger, a change in state of the CO₂, which is liquid at 20 bar/−20° C., is achieved due to the fall in the temperature.

The operation of a condensation gas boiler uses the same principle as a conventional boiler and in addition makes it possible to take advantage of all the energy produced during the combustion of the gas.

In a conventional boiler, the water circuit of the central heating is heated by virtue of the combustion of natural gas. The condensation gas boiler takes advantage of the energy contained in the combustion flue gases. The flue gases emitted during the combustion of natural gas contain steam; the latter condenses, releasing heat. The return water from the heating circuit is heated up by virtue of this energy, and the discharge of the water released during the condensation (the condensates) takes place via the wastewater system.

By way of example, it may be considered that, for the anesthesia of chickens or pigs, the CO₂ requirement is advantageously synchronized with the hot water requirement; the fall in temperature obtained by the upgrading of the cold of the liquid oxygen makes it possible to purify the CO₂ gas (at 20 bar and −20° C. for example, only the CO₂ will be liquid).

Still by way of example, for other applications, for example greenhouses for the cultivation of plants, it is advantageous to store the liquid CO₂ in a conventional CO₂ tank in order to use it at another time.

By way of example, for tomato greenhouses, greenhouse growers heat the greenhouses at night, and thus produce CO₂ at night, whereas they require CO₂ during the day for photosynthesis; it is thus necessary to store the CO₂ in a cryogenic tank.

Of course, a person skilled in the art knows the existence of a state of the prior art, which can in particular be illustrated by the documents JP2009/203860 and WO2022/070125, which relate to installations of power station or generator type, where, by way of example in the document JP2009/203860, a turbine (10) is fed with a supercritical fluid, for example nitrogen or for example CO₂, where the fluid discharged by the combustion is purified of its CO₂ by exchange with liquid oxygen, the CO₂ thus recovered is directed to a suitable tank (“Water goes to the waste water reservoir 83 and carbon dioxide goes to the waste carbon dioxide reservoir 84”) for environmental reasons (zero emission of CO₂, ozone layer, and the like).

In all cases:
these prior documents do not include an oxy-fuel combustion boiler for feeding a given site with hot water;
these prior documents do not describe a situation where this site, which consumes hot water, moreover requires, for an item of equipment of this site (such as an abattoir or also a greenhouse for the cultivation of plants), gaseous CO₂ or a gas mixture comprising CO₂;
these prior documents do not describe the use of the CO₂ recovered in the flue gases of the boiler to feed such an item of equipment which consumes CO₂.

The present invention then relates to a process for feeding, with gaseous CO₂, a site comprising an installation requiring CO₂ or a mixture comprising CO₂, such as an abattoir or also a greenhouse for the cultivation of plants, which is characterized by the implementation of the following measures:
there is available, within said site, a boiler capable of supplying hot water to the site, this boiler employing oxy-fuel combustion between a fuel and pure oxygen, the oxygen feeding the boiler being obtained from a liquid oxygen source present on the site;
all or part of the CO₂ contained in the flue gases produced by the boiler is recovered, in that heat exchange between said flue gases and the liquid oxygen in a exchanger is arranged.

The present invention thus also relates to a process and apparatus for the purification and liquefaction of CO₂ on the user's site, these being achieved by upgrading the cold of the liquid oxygen present on the site.

This liquefaction of the CO₂ can be preceded by one or more treatments of the flue gases by physical and/or chemical, but also cryogenic, separation methods targeted at:
heating the oxygen and the fuel gas, in order to improve the combustion and to reduce the discharges of nitrogen oxides;
condensing the steam of the flue gases and recovering the heat of condensation or latent energy (by lowering the temperature of the flue gases, the steam is transformed into liquid water);
removing possible dust generated by the furnace of the boiler (refractory dust).

By way of example, the oxy-fuel combustion with methane requires 64 g of oxygen per 16 g of CH₄ and will produce 36 g of water, which will be easily separated, and 44 g of CO₂. The O₂/CO₂ ratio is thus 64/44=1.45.

CO₂ requires approximately 85 kcal/kg to change from +20° C. to −20° C. (20 bar). Liquid oxygen releases 71.7 kcal/kg at 8 bar from its liquid form at a temperature of −30° C. The theoretical refrigerating capacity available is thus (71.7×1.45)+103 kcal to liquefy one kg of CO₂.

The abovementioned advantages of the use of liquid oxygen make it possible for the user of such an oxy-fuel combustion to finance a good part (indeed even all) of the oxygen required for the combustion. Knowing that the choice of the sequestration of the CO₂ is to upgrade this gas with regard to processes which habitually use a commercial CO₂, the user has available here a widely competitive CO₂; furthermore, this user has reduced his CO₂ discharges by reducing his consumption of CH₄ and by not using a “commercial” source of CO₂, since the source is recovered on the site.

The appended FIG. 1 illustrates an example of an item of equipment suitable for the implementation of the invention, in the case of use on the site under consideration for the tunnel anesthetization of poultry. In the case of this installation, the work was carried out under conditions where the CO₂ requirement is synchronized with the hot water requirement: hot water is used to pluck the poultry and gaseous CO₂ is used to put the poultry to sleep. In this case, it was not necessary to liquefy the CO₂.

### Nomenclature

The nomenclature of the elements present in this FIG. 1 is as follows:
1: liquid oxygen storage.
2: O₂ vaporizer: this exchanger 2 carries out the heat exchange between the flue gases and the liquid oxygen; the temperature of the flue gases is lowered therein to a temperature typically close to 2° C. in order to remove as much water as possible, and then to retain CO₂.
3: plate for regulation of the injection of O₂ and CH₄.
4: boiler.
5: burner.
6: module for analysis of the flue gases.
7: cryogenic purifier.
8: low-pressure turbine (the turbine 8 makes it possible to suck up the flue gases originating from the exchanger 2 and to send them into the tunnel 20, while moreover countering the pressure drops occurring at the various preceding stages).
9: regulating valve (which is controlled by the anesthesia tunnel; if the tunnel is shutdown, the gases are sent to the outside, whereas, the more the tunnel requires CO₂, the more the valve is opened toward the circuit of the tunnel).
10: CH₄ heater (this heater makes it possible to heat the fuel gas before sending it into the burner).
11: O₂ heater (this heater makes it possible to heat the oxygen before sending it into the burner).
12: flue gases condenser (makes it possible to heat the water before sending it into the boiler).
13: municipal or drilling water, which will be heated for the use of the site, but this water, which is cold (generally from 10° C. to 20° C.), also makes it possible to lower the temperature of the flue gases at the boiler outlet.
14: fuel necessary to heat the water, via the boiler; this fuel can also be heated in order to increase the combustion efficiency.
20: anesthesia tunnel for poultry.

### BRIEF DESCRIPTION OF THE DRAWING

For a further understanding of the nature and objects for the present invention, reference should be made to the following detailed description, taken in conjunction with the accompanying drawing, in which like elements are given the same or analogous reference numbers and wherein:

FIG. 1 illustrates a system for supplying CO₂ gas to a facility that requires CO₂ or a mixture comprising CO₂, such as an abattoir or a greenhouse for cultivating plants, in accordance with an exemplary embodiment of the present invention.

### DETAILED DESCRIPTION OF PREFERRED EMBODIMENTS

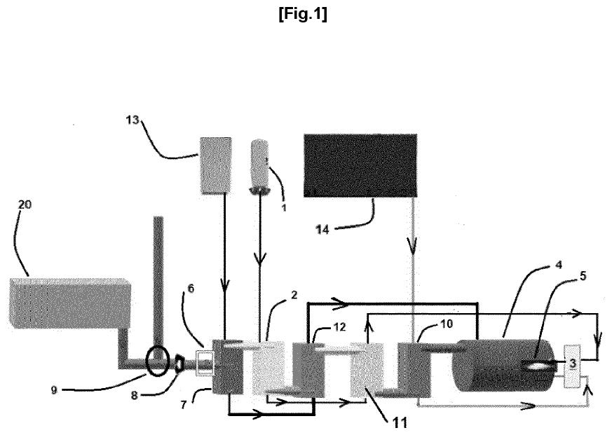

That which takes place in the various items of equipment present in FIG. 1, and also an implementational example giving the thermal characteristics of the fluids involved at each stage, data representing only one implementational example which are only illustrative of the items of equipment and operating conditions used here, are described in detail in that which follows:
In the boiler 4: the municipal water enters therein at a temperature in the vicinity of 25° C. and emerges therefrom at a temperature in the vicinity of 85° C.; the flue gases exit from the boiler at a temperature in the vicinity of 220° C.
In the heater 10: the fuel gas enters at a temperature in the vicinity of 15° C. and emerges therefrom at a temperature in the vicinity of 95° C., and the flue gases exit from this element 10 at a temperature in the vicinity of 210° C.
In the heater 11: the oxygen enters at a temperature in the vicinity of 5° C. and emerges therefrom at a temperature in the vicinity of 95° C., and the flue gases exit from this element 11 at a temperature in the vicinity of 200° C.
In the condenser 12, the municipal water enters therein at a temperature in the vicinity of 5° C. and exits therefrom at a temperature in the vicinity of 25° C., and the flue gases exit from this element 12 at a temperature in the vicinity of 90° C. (the exchanger 2 thus makes it possible to recover heat from the flue gases and preheats the water which will enter the boiler (principle of the condensation boilers)).
In the exchanger 2, the oxygen enters at a temperature in the vicinity of −183° C. and exits therefrom at a temperature in the vicinity of +5° C., and the flue gases exit from this element 2 at a temperature in the vicinity of +2° C. In this stage, the water is completely condensed and only CO₂ remains.
In the element 7, the municipal water enters therein at a temperature in the vicinity of 15° C. and emerges therefrom at a temperature in the vicinity of 5° C., and the flue gases exit from this element 7 at a temperature in the vicinity of 10° C. (the exchanger 2 thus makes it possible to raise the temperature of the CO₂ by around 10-12° C. after having removed the water therefrom, which is required for such anesthesia applications according to the legislations in force).

Consideration is given, in that which follows, to the example of a 40 tonne/h abattoir, anesthetizing under the following conditions:
A CO₂ requirement of 5 g per kg of poultry.
For production of 10 000 chickens per hour, considering chickens weighing on average 2.2 kg each, a requirement of 110 kg of CO₂ per hour is obtained, hence 2500 mol/h of CO₂, and thus 2500×2=5000 mol/h of oxygen, i.e. 160 kg of oxygen.
2500 mol of CH₄×16=40 kg of CH₄ per hour.
Considering that the combustion of methane at 25° C. releases an energy of 39.77 MJ/m³ (55.53 MJ/kg), i.e. 11.05 kWh/m³ (15.42 kWh/kg=616 kWh).
The weight of CO₂ released per mole of octane consumed is 44 g.
The methane consumption/CO₂ discharges ratio is 44/16=2.75 g.
1 kg of methane discharges 2.75 kg of CO₂.
A saving of 20% with regard to the CH₄ (saving in energy with nitrogen absence+rise T° C. oxidant/fuel, radiative transfers): (616/100)×20=123 kW
123×€0.10 per kW gas (price which can be regarded as reference)=€12.3 per hour
Under the conditions of the present simulation, the saving with regard to natural gas makes it possible to pay a part of the oxygen for the production of the CO₂:

160×€0.088 per kg=€14.08 O₂ per hour

14.08-12.3=€1.78 per 110 kg of CO₂, i.e. 1.78/110×1000=16.1.
Which amounts to a cost of the CO₂ at €16.1/tonne.
While no saving occurs with regard to the combustion, the cost of the CO₂ is in the vicinity of €134.5 per tonne (to be compared with approximately €150/tonne for commercial CO₂).

In this field of tunnels for the anesthesia of poultry, it is generally considered that it is desired to achieve a content of CO₂ in the tunnel which is at least 55%.

And thus it is necessary to emphasize the fact that an air/CH₄ combustion would not make it possible to achieve sufficient values of CO₂ in the flue gases (the presence of nitrogen in the combustion air limits the concentration of CO₂ to 11.5%).

The example of a tunnel poultry anesthetization installation has been enlarged upon in detail in FIG. 1, where the operation was carried out under conditions where the CO₂ requirement is synchronized with the hot water requirement: hot water is used to pluck the poultry and gaseous CO₂ is used to put the poultry to sleep; it is consequently not necessary here to liquefy the CO₂.

However, in other applications, it will be useful to liquefy the CO₂; mention may be made, for example, of the case of use of the CO₂ by greenhouse growers; the CO₂ requirement corresponds to the photosynthesis of the plant thus in the day, whereas the requirement to heat the greenhouse is predominantly effective overnight (when it is colder).

Thus, for these users, it is advantageous to liquefy the CO₂ at night in order to distribute it during the day (in sunlight).

The exchanger 2 will then be configured to drop to −20° C. and 20 bar, by having added a compressor at the inlet of the exchanger 2, the means 8 then no longer having a reason to be in such an application (it should be noted that this “greenhouse grower” variant is not represented in FIG. 1).

The exchanger 2 for carrying out such a liquefaction can also be a cryocondenser, which is a heat exchanger operating at low temperature; the gaseous effluent resulting from the industrial process enters the interior of a shell-and-tube, then advances through a series of baffles, around a fin tube bundle in which a liquid cryogen circulates.

As has been said, CO₂ is a gas which changes in state to the solid phase at a pressure close to 4.7 bar; it is thus necessary to avoid approaching this pressure.

A pressure between 16 bar and 20 bar is economically favorable, while a temperature of −20° C. requires few capital expenditures in terms of insulation.

It is thus generally considered that the pair “20 bar, −20° C.” represents the best compromise.

Reference herein to “one embodiment” or “an embodiment” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The singular forms “a”, “an” and “the” include plural referents, unless the context clearly dictates otherwise.

“About” or “around” or “approximately” in the text or in a claim means ±10% of the value stated.

As used herein, “room temperature” in the text or in a claim means from approximately 20° C. to approximately 30° C.

The term “ambient temperature” refers to an environment temperature approximately 20° C. to approximately 30° C.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

1. A process for feeding, with gaseous CO₂, a site comprising an installation requiring CO₂ or a mixture comprising CO₂, the process comprising the steps of:
supplying hot water to the site using a boiler, the boiler employing oxy-fuel combustion between a fuel and pure oxygen, the pure oxygen fed to the boiler being obtained from a liquid oxygen source present on the site;
recovering all or part of CO₂ contained in the flue gases produced by the boiler, arranging heat exchange between the flue gases and the liquid oxygen in an heat exchanger; and
recovering CO₂ in its gaseous form or its liquid form, while having purified in the heat exchange all or part of water comprised in the flue gases.

2. The process as claimed in claim 1, wherein CO₂ recovered in its gaseous form is stored or (sequestered) for the purpose of subsequent use on the site under consideration, or else used “as a just-in-time stream”, as a stream “synchronized” with a hot water requirement.

3. The process as claimed in claim 1, wherein the CO₂ recovered in its liquid form is stored in a tank as liquid CO₂ for the purpose of subsequent use on the site under consideration.

4. The process as claimed in claim 3, wherein the heat exchanger in which heat exchange between the flue gases and the liquid oxygen is arranged is configured to convey the flue gases entering the heat exchanger under pressure and temperature conditions to liquefy CO₂ present in the flue gases, thus taking advantage of cold of the liquid oxygen present on the site, thereby without a need for a contribution of electrical energy.

5. The process as claimed in claim 1, wherein the installation requiring CO₂ is an installation for anesthesia of poultry or animals, before slaughtering.

6. The process as claimed in claim 1, wherein the installation requiring CO₂ is an installation for cultivation of plants in a greenhouse.

7. The process as claimed in claim 6, wherein the requirement for CO₂ occurs essentially during the day, whereas the requirement for heating the greenhouse occurs essentially during the night, CO₂ recovered in liquid form during the night being stored in a tank for liquid CO₂ for the purpose of use of CO₂ during the day when the greenhouse requires CO₂.

8. The process as claimed claim 1, wherein the heat exchange between the flue gases and the liquid oxygen is preceded by one or more treatments of the flue gases by physical and/or chemical and/or cryogenic separation methods, the one or more treatments comprising:
heating the liquid oxygen and the fuel gas, in order to improve the combustion occurring in the boiler and to reduce discharges of nitrogen oxides;
condensing a steam of the flue gases; and
removing possible dust generated by a furnace of the boiler.

9. A device for feeding, with gaseous CO₂, a site comprising an installation requiring CO₂ or a mixture comprising CO₂, the device comprising:
a boiler, configured to and capable of providing hot water to the site, the boiler employing oxy-fuel combustion between a fuel and pure oxygen, the oxygen fed to the boiler being obtained from a liquid oxygen source present on the site; and
a heat exchanger, configured to arrange heat exchange between the flue gases and the liquid oxygen in order to recover all or part of CO₂ contained in the flue gases produced by the boiler, and to feed to, using the recovered CO₂, the installation;
wherein the heat exchanger is configured to recover, according to the use which will be made thereof on the site under consideration, CO₂ in its gaseous form or its liquid form, while having purified in the heat exchange all or part of the water comprised in the flue gases.

10. The device as claimed in claim 9, wherein the heat exchanger in which the heat exchange between the flue gases and the liquid oxygen is arranged is configured to convey the flue gases entering the heat exchanger under pressure and temperature conditions to liquefy CO₂ present in the flue gases, thus taking advantage of cold of the liquid oxygen present on the site, thereby without a need for a contribution of electrical energy.

11. The device as claimed in claims 9, further comprising steps for treatment of the flue gases before their arrival in the heat exchanger, wherein the treatment steps employing physical and/or chemical and/or cryogenic separation methods, the treatment steps comprising one or more of the following actions:
heating the oxygen and the fuel gas, in order to improve the combustion occurring in the boiler and to reduce discharges of nitrogen oxides;
condensing a steam of the flue gases; and
removing possible dust generated by a furnace of the boiler.

12. The device as claimed in claim 9, wherein the installation requiring CO₂ is an installation for anesthesia of poultry or animals, before slaughtering.

13. The device as claimed in claim 9, wherein the installation requiring CO₂ is an installation for cultivation of plants in a greenhouse.
